(19) United States
(12) Patent Application Publication
(10) Pub. No.: US 2007/0133626 A1
(43) Pub. Date: Jun. 14, 2007

(54) Mid-infrared raman fiber laser system

(75) Inventors: Joon Tae Ahn, Daejeon-city (KR); Hong Seok Seo, Daejeon-city (KR); Woon Jin Chung, Seoul (KR); Bong Je Park, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/454,675

(22) Filed: Jun. 15, 2006

(30) Foreign Application Priority Data
Dec. 12, 2005 (KR) 10-2005-0121976

(51) Int. Cl. H01S 3/30

(52) U.S. Cl. 372/6

(57) ABSTRACT

Provided is a mid-infrared Raman optical fiber laser system that oscillates in a 3.0 to 4.0 μm range using a high power laser in a near-infrared wavelength region and a silica optical fiber as a pump light source and a gain medium, respectively. The system includes a plurality of pairs of FBGs (Fiber Bragg Gratings) that are disposed at either end of an optical fiber inducing Raman scattering and obtains a lasing wavelength using a plurality of stokes shifts generated by energy decrease of about 1330 cm⁻¹ during the Raman scattering; and a pump light source that is disposed at one end of FBG pair and induces the Raman scattering in the optical fiber.

### CROSS-REFERENCE TO RELATED PATENT APPLICATION

This application claims the benefit of Korean Patent Application No. 10-2005-0121976, filed on Dec. 12, 2005, in the Korean Intellectual Property Office, the disclosure of which is incorporated herein in its entirety by reference.

### BACKGROUND OF THE INVENTION

1. Field of the Invention

The present invention relates to an optical fiber laser, and more particularly, to a Raman optical fiber laser with a mid-infrared lasing wavelength that uses a silica optical fiber as a gain medium.

2. Description of the Related Art

Optical fiber lasers guide pump light emitted from a pump light source or laser light into an optical fiber. An optical fiber laser provides high efficiency of conversion of pump light and enables a simple cavity design by eliminating alignment in optical components. It also has excellent mode characteristics due to stable cavity alignment and power output and is easy to use because an output optical fiber terminal can move freely. Examples of an optical fiber laser may include a yitterbium (Yb) laser oscillating at about 1 μm, an erbium (Er) laser oscillating at about 1.5 μm, and a thulium (Tm) oscillating at 2 μm. A high power, wavelength-variable optical fiber laser has been widely used in commercial, industrial, medical, military, academic, and other applications. An optical fiber used in the laser is typically made of a silica-based material having low optical loss and high thermal durability. Because a technology for manufacturing optical devices necessary for constructing a laser has advanced and melted connection between optical devices is possible, a silica-based optical fiber laser becomes suitable for use in high power optical fiber laser.

A mid-infrared wavelength range from about 2 to about 20 μm is suitable for use in medical, military, environmental applications. Development of solid state lasers, semiconductor lasers and optical fiber lasers in the mid-infrared wavelength region is under way. Optical fiber lasers with a wavelength of about 2.8 μm are still in the experimental stage. For optical fiber lasers operating at a wavelength band above about 3 μm, only basic physical properties such as physical and optical characteristics of a gain medium are known.

An optical fiber laser is realized by using an optical fiber doped with a rare-earth element as a gain medium or using stimulated Raman scattering (SRS) that is a non-linear effect in an optical fiber. Typical examples of a rare-earth element undergoing energy shift into the mid-infrared wavelength region include praseodymium (Pr), neodymium (Nd), Terbium (Tb), and dysprosium (Dy). However, a silica optical fiber having phonon energy of about 1100 cm⁻¹ cannot obtain energy shift into a mid-infrared wavelength region even if it contains a rare-earth element. A non-oxide optical fiber having phonon energy of less than about 600 cm⁻¹ and which is doped with a rare-earth element may obtain energy shift into the mid-infrared wavelength region but is difficult to manufacture. Thus, it cannot be applied to an optical fiber laser oscillating above 3 μm.

In SRS, the energy of incident light shifts to another level by the amount of energy due to molecular vibrations. The SRS process uses stokes shift (a loss of photon energy) to realize a Raman optical fiber laser or Raman optical fiber amplifier. The optical fiber typically made of silica for optical communications is used as a SRS gain medium and has a stokes shift of about 450 cm⁻¹ that can be converted into a frequency of about 13.5 THz or wavelength of about 100 nm in the 1.5 μm communication wavelength band.

When a pump light source has an appropriate intensity, a Raman optical fiber laser consists of a plurality of cavities that can oscillate at a wavelength that increases by the multiple of stokes shift compared to the wavelength of the pump light source (pump wavelength). Thus, the Raman optical fiber laser can oscillate at wavelength that is significantly longer than the wavelength of pump light emitted by the pump light source. For example, a pump light source with a wavelength of 1.48 μm for an optical amplifier operating in the 1.5 μm communication wavelength band can be realized by using 1.06 μm Nd:YAG laser or 1.12 μm Er/Yb optical fiber laser as a pump light source and a typical silica optical fiber as a SRS gain medium. The pump light source can produce high output power of several watts but suffers low efficiency because it has to undergo five stokes shifts to obtain lasing wavelength from the wavelength of pump light.

Meanwhile, it is known that typical silica optical fiber doped with P₂O₅, energy shift of about 1330 cm⁻¹ occurs in addition to energy shift of about 450 cm⁻¹. FIG. 1 illustrates energy shift induced by SRS in a P₂O₅ silica optical fiber.

Referring to FIG. 1, energy shift of about 450 cm⁻¹ occurs in a wide band while energy shift of about 1330 cm⁻¹ occurs in a narrow band. When energy shift of about 1330 cm⁻¹ is used, a laser can oscillate at a wavelength longer than the wavelength of a pump light compared to when energy shift of about 450 cm⁻¹ is used. A 1.06 or 1.12 μm laser uses energy shift of about 1330 cm⁻¹ within the P₂O₅ silica optical fiber, thus realizing a Raman optical fiber laser with a wavelength of 1.48 μm. The laser uses two stokes shifts to increase the efficiency of converting pump light.

By using stokes shift of about 1330 cm⁻¹ in the P₂O₅ silica optical fiber, it is also possible to manufacture a mid-infrared optical fiber laser using a currently commercialized high power optical fiber laser in the 1.7 to 2.1 μm wavelength region as a pump light source. Thus, there is a need to develop a Raman optical fiber laser system that can oscillate in the mid-infrared wavelength region (e.g., 3.0 to 4.0 μm).

### SUMMARY OF THE INVENTION

The present invention provides a mid-infrared Raman optical fiber laser system that oscillates in a 3.0 to 4.0 μm range using a high power laser in a near-infrared wavelength region and a silica optical fiber as a pump light source and a gain medium, respectively.

According to an aspect of the present invention, there is provided a mid-infrared Raman optical fiber laser system including: a silica optical fiber that is doped with P₂O₅ and induces Raman scattering; a plurality of pairs of FBGs (Fiber Bragg Gratings) that are disposed at either end of the optical fiber to obtain a lasing wavelength using a plurality of stokes shifts generated by energy decrease of about 1330 cm⁻¹ during the Raman scattering; and a pump light source that is disposed at one end of FBG pair and induces the Raman scattering in the optical fiber.

The mid-infrared wavelength may be in the range of 3.0 to 4.0 μm. The pump light source inducing the Raman scattering used to obtain a lasing wavelength using the stokes shift may have a wavelength of 1.60 to 1.85 μm.

The system further includes a FBG for resonator that is disposed at a side of the optical fiber opposing the pump light source and reflects pump light remaining after the stokes shift into the optical fiber.

According to another aspect of the present invention, there is provided a mid-infrared Raman optical fiber laser system including: a zero water peak silica optical fiber inducing Raman scattering; a plurality of pairs of FBGs (Fiber Bragg Gratings) that are disposed at either end of the optical fiber to obtain a lasing wavelength using a plurality of stokes shifts generated by energy decrease of about 450 cm⁻¹ during the Raman scattering; and a pump light source that is disposed at one end of FBG pair and induces the Raman scattering in the optical fiber.

The optical fiber may be doped with a predetermined amount of P₂O₅. The pump light source inducing the Raman scattering used to obtain a lasing wavelength using the stokes shift generated by energy decrease of about 450 cm⁻¹ may have a wavelength of 1.90 to 2.15 μm.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates energy shift induced by stimulated Raman scattering (SRS) in a P₂O₅ doped silica optical fiber;

FIG. 2 is a graph illustrating transmittance with respect to wavelength of a silica optical fiber according to an embodiment of the present invention;

FIG. 3 illustrates a mid-infrared Raman optical fiber laser system according to an embodiment of the present invention; and

FIG. 4 is a mid-infrared Raman optical fiber laser system according to another embodiment of the present invention.

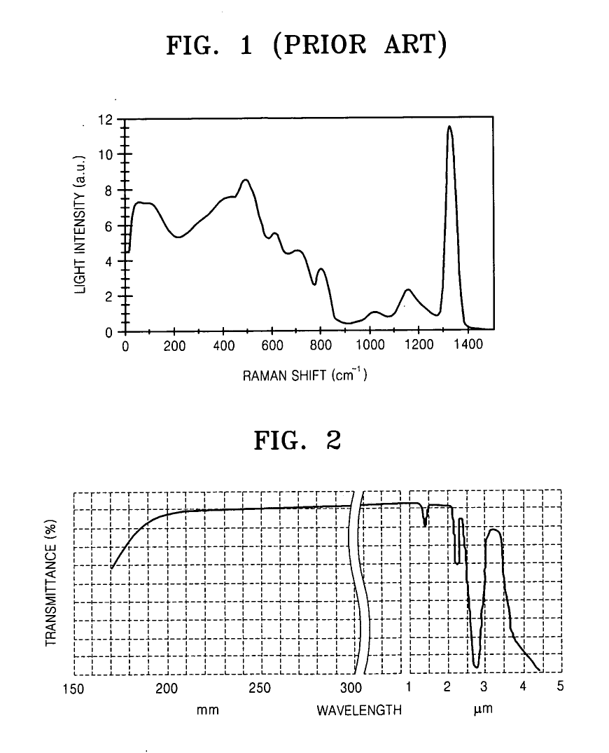

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements, and thus their description will be omitted.

An embodiment of the present invention provides a mid-infrared optical fiber laser system using mid-infrared wavelength transmission band of a silica optical fiber and stimulated Raman scattering (SRS) characteristics of a P₂O₅ silica optical fiber. The silica optical fiber have already been used in optical fiber couplers, wavelength division multiplexing (WDM) fiber couplers, and optical fiber Bragg gratings. Because use of a silica optical fiber allows the use of various optical device manufacturing technologies and optical fiber connection technologies, it is very easy to realize a mid-infrared Raman optical fiber laser.

Typically, a silica optical fiber has high transmittance above 90% in a wavelength region less than 2.0 μm. The silica optical fiber has been mainly used for visible light to near-infrared region and is known to suffer significant optical loss in a longer wavelength region. However, the silica optical fiber has a transmittance greater than about 70% in a wavelength region between 3.0 and 3.5 μm. In this case, the maximum transmittance is near 80%.

FIG. 2 is a graph illustrating transmittance with respect to wavelength of a silica optical fiber that can be used in an embodiment of the present invention. It is widely known that a silica optical fiber cannot be used as a gain medium containing a rare-earth ion undergoing energy shift into a mid-infrared wavelength region due to high phonon energy. However, as evident by FIG. 2, the silica optical fiber can carry a laser beam in a mid-infrared wavelength region due to high transmittance at wavelength of 3 μm, which will be described with reference to the following Table 1. Thus, a mid-infrared Raman optical fiber laser can be realized by using the silica optical fiber as a SRS gain medium and manufacturing and melting optical devices necessary for constructing a laser cavity for connection.

Table 1 shows first stokes wavelength and second stokes wavelength that is a lasing wavelength for a pump wavelength when energy shift of about 1330 cm⁻¹ in the optical fiber is used. In this case, the first stokes wavelength and pump wavelength were measured by setting the lasing wavelength to a transmission wavelength range of 3.0 to 3.5 μm of the silica optical fiber. It is also assumed that frequency and light speed corresponding to energy shift of about 1330 cm⁻¹ are 40 THz and 300,000 km/sec, respectively. The lasing wavelength may be set to 3.0 to 4.0 μm if necessary.

TABLE 1

| Lasing wavelength | First stokes shift | Pump wavelength |
|---|---|---|
| (μm) | (μm) | (μm) |
| 3.5 | 2.386 | 1.810 |
| 3.4 | 2.339 | 1.783 |
| 3.3 | 2.292 | 1.755 |
| 3.2 | 2.243 | 1.727 |
| 3.1 | 2.193 | 1.697 |
| 3.0 | 2.143 | 1.667 |

As shown in the Table 1, pump light with wavelength of about 1.67 to 1.81 μm should be used to obtain a Raman optical fiber laser operating in a mid-infrared wavelength region of 3.0 to 3.5 μm. In this case, the first stokes wavelength is between 2.13 to 2.39 μm. In order to realize a mid-infrared Raman optical fiber laser, the silica optical fiber must have high transmittance at first stokes wavelength as well as at second stokes wavelength that is the lasing wavelength for efficient lasing. The pump wavelength may be between about 1.75 to 1.80 μm. Currently, a commercial optical fiber laser with lasing wavelength of 1.7 to 2.1 μm and output power of several tens of watts can be used as a pump light source.

Meanwhile, absorption peaks between 1 and 3 μm in FIG. 2 are detected due to water contained in the silica optical fiber. Recently, a zero water peak single-mode fiber with lowest water absorption peak has been developed as a standard optical fiber for optical communications. Thus, it is possible to manufacture a P₂O₅-doped zero water peak fiber (“P₂O₅ zero water peak fiber”) and realize a mid-infrared Raman optical fiber laser using the P₂O₅ zero water peak fiber as a SRS gain medium. The P₂O₅ zero water peak fiber without absorption peaks makes more wavelengths available for pump wavelength because it has no restriction on selecting a first stoke wavelength. When a zero water peak silica optical fiber is used as a Raman gain medium, a mid-infrared Raman optical fiber laser with wavelength of 3 to 3.5 μm can be manufactured using the resulting energy shift of about 450 cm⁻¹.

Table 2 shows lasing wavelength, first through third stokes wavelengths and pump wavelength when energy shift of about 450 cm⁻¹ is used. In this case, the first through third stokes wavelengths and pump wavelength were calculated by setting a target wavelength to a lasing wavelength of 3.0 to 3.5 μm. It is also assumed that frequency and light speed corresponding to energy shift of about 450 cm⁻¹ are 13.5 THz and 300,000 km/sec, respectively. The lasing wavelength may be set to 3.0 to 4.0 μm if necessary.

TABLE 2

| Lasing | Third stokes | Second | First | Pump |
|---|---|---|---|---|
| wavelength | shift | stokes | stokes | wavelength |
| (μm) | (μm) | (μm) | (μm) | (μm) |
| 3.5 | 3.024 | 2.662 | 2.377 | 2.147 |
| 3.4 | 2.949 | 2.603 | 2.330 | 2.109 |
| 3.3 | 2.873 | 2.544 | 2.283 | 2.070 |
| 3.2 | 2.797 | 2.484 | 2.235 | 2.030 |
| 3.1 | 2.720 | 2.424 | 2.285 | 1.990 |
| 3.0 | 2.643 | 2.362 | 2.135 | 1.948 |

As shown in Table 2, the number of stokes shifts is increased from pump wavelength to lasing wavelength because energy shift of about 450 cm⁻¹ is lower than energy shift of about 1330 cm⁻¹ in the P₂O₅ optical fiber. As the number of stokes shifts decreases, the number of optical devices in the laser decreases and efficiency of conversion of pump light increases. Thus, the pump light may preferably have a large wavelength. Furthermore, with a reduced number of stokes shifts, a commercial high power optical fiber laser in a wavelength region between 1.7 and 2.1 μm can be obtained, thus achieving an efficient mid-infrared Raman optical fiber laser.

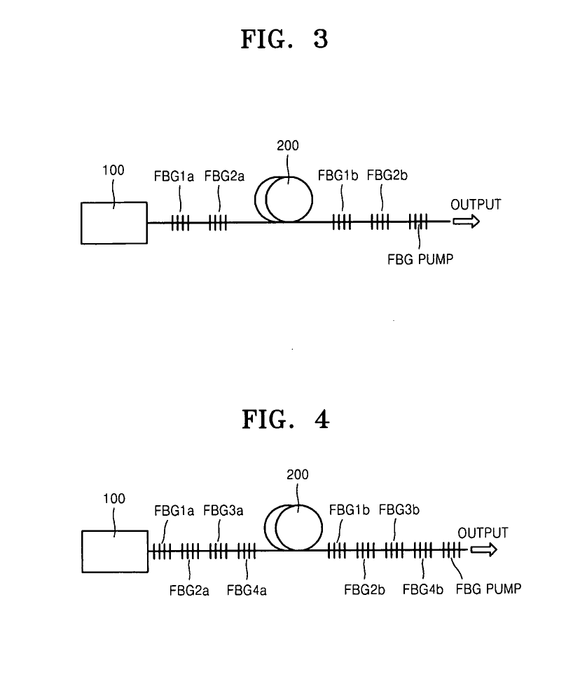

FIG. 3 illustrates a mid-infrared Raman optical fiber laser system according to an embodiment of the present invention using a P₂O₅ silica optical fiber as a gain medium and an optical fiber laser with output power of several tens of watts and which oscillates between 1.7 and 2.1 μm as a pump light source.

Referring to FIG. 3, two pairs of fiber Bragg gratings (FBG) FBG1 and FBG2 forming a resonator necessary for Raman lasing are disposed at either end of a gain medium 200. In this case, the FBG1 has a central wavelength of a pump wavelength to a first Raman shifted wavelength and FGB2 has a central wavelength corresponding to a second Raman shifted wavelength, i.e., a lasing wavelength. As the reflectance of FBG1a and FBG2a at the input end of the gain medium 200 approaches 100%, the efficiency of conversion of pump light increases. The reflectance of the FGB1b at the output end is adjusted to near 100% to increase the conversion efficiency of pump light while the reflectance of the FBG2b is adjusted suitably to less than 100% according to target laser power. A FBG pump at the output end reflects a pump wavelength that has passed through the FBG1b and FBG 2b into the gain medium 200 in order to increase the conversion efficiency of pump light. The FBG pump may have a central wavelength equal to that of a pump light source and a reflectance of almost 100%.

Meanwhile, the central wavelength of the FBG1 for oscillating a laser using first stokes shift may be selected suitably to prevent optical loss of the silica optical fiber. When a P₂O₅ roped silica optical fiber is used as a zero water peak optical fiber shown in FIG. 2, there is no restriction on selecting first stokes wavelength due to absorption peak.

FIG. 4 illustrates a mid-infrared Raman optical fiber laser system according to another embodiment of the present invention with lasing wavelength of 3.3 μm as shown in Table 2 and which uses a zero water peak optical fiber as a gain medium and several watt-class optical fiber laser oscillating near 2.0 μm as a pump light source.

Referring to FIG. 4, four pairs of fiber Bragg gratings FBG1 through FBG4 forming a resonator necessary for Raman lasing are disposed at either end of a gain medium 200. In this case, the FBG1 through FBG4 have central wavelengths of about 2.283, 2.544, 2.873, and 3.3 μm, respectively, and pump light has a wavelength of about 2.07 μm. The reflectance of FBG1a, FBG2a, FBG3a and FBG4a at the input end of the gain medium 200 and FBG1b, FBG2b and FBG3b at the output end may be close to 100% in order to increase the conversion efficiency of pump light. On the other hand, FGB4b at the output is adjusted suitably to less than 100% according to target laser power. A FBG pump at the output end reflects a pump wavelength that has passed through the FBG1 through FBG4 into the gain medium 200 in order to increase the conversion efficiency of pump light. The FBG pump may have a central wavelength equal to that of a pump light source and a reflectance of almost 100%.

While FIG. 4 shows the pump light has a wavelength around 2.0 μm, the pump light may have a shorter wavelength. In this case, the number of pairs of FBGs is increased. Even if the number of FBG pairs is increased, the reflectance of each FBG may be close to 100% except for an FBG at the output end with a central wavelength corresponding to a lasing wavelength.

The mid-infrared Raman optical laser system according to the present invention described above can achieve a mid-infrared lasing wavelength by using a P₂O₅ -doped silica optical fiber as a gain medium and obtaining stokes shift using FBG pairs. The mid-infrared Raman optical laser system can also have a mid-infrared lasing wavelength by using a zero water peak silica optical fiber as a gain medium and obtaining stokes shift using FBG pairs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A mid-infrared Raman optical fiber laser system comprising:
a silica optical fiber that is doped with P₂O₅ and induces Raman scattering;
a plurality of pairs of FBGs (Fiber Bragg Gratings) that are disposed at either end of the optical fiber to obtain a lasing wavelength using a plurality of stokes shifts generated by energy decrease of about 1330 cm⁻¹ during the Raman scattering; and
a pump light source that is disposed at one end of FBG pair and induces the Raman scattering in the optical fiber.

2. The system of claim 1, wherein the mid-infrared wavelength is in the range of 3.0 to 4.0 μm.

3. The system of claim 1, wherein the silica optical fiber is a zero water peak silica optical fiber.

4. The system of claim 1, wherein the pump light source inducing the Raman scattering used to obtain a lasing wavelength using the stokes shift has a wavelength of 1.60 to 1.85 μm.

5. The system of claim 1, wherein when the central wavelength of the FBG pair for oscillating at a first stokes shifted wavelength obtained from the first stokes shift is selected in a range near 2.3 μm, the pump light source has a wavelength of 1.7 to 1.8 μm.

6. The system of claim 1, further comprising a FBG for resonator that is disposed at a side of the optical fiber opposing the pump light source and reflects pump light remaining after the stokes shift into the optical fiber.

7. The system of claim 1, wherein an optical fiber laser containing thulium (Tm) is used as the pump light source.

8. A mid-infrared Raman optical fiber laser system comprising:
a zero water peak silica optical fiber inducing Raman scattering;
a plurality of pairs of FBGs (Fiber Bragg Gratings) that are disposed at either end of the optical fiber to obtain a lasing wavelength using a plurality of stokes shifts generated by energy decrease of about 450 cm⁻¹ during the Raman scattering; and
a pump light source that is disposed at one end of FBG pair and induces the Raman scattering in the optical fiber.

9. The system of claim 8, wherein the mid-infrared wavelength is in the range of 3.0 to 4.0 μm.

10. The system of claim 8, wherein the optical fiber is doped with a predetermined amount of P₂O₅.

11. The system of claim 8, wherein the pump light source inducing the Raman scattering used to obtain a lasing wavelength using the stokes shift has a wavelength of 1.90 to 2.15 μm.

12. The system of claim 8, further comprising a FBG for resonator that is disposed at a side of the optical fiber opposing the pump light source and reflects pump light remaining after the stokes shift into the optical fiber.
